(19) United States
(12) Patent Application Publication
(10) Pub. No.: US 2012/0262918 A1
(43) Pub. Date: Oct. 18, 2012

(54) LIGHTING UNIT HAVING LIGHT-EMITTING DIODES

(75) Inventors: David Delhorme, Vouel (FR); Aude Montgermont, Paris (FR); Jingwei Zhang, Massy (FR)

(73) Assignee: SAINT-GOBAIN GLASS FRANCE, Courbevoie (FR)

(21) Appl. No.: 13/502,994

(22) PCT Filed: Oct. 19, 2010
(86) PCT No.: PCT/FR2010/052219

§ 371 Date: Jun. 29, 2012

(30) Foreign Application Priority Data
Oct. 20, 2009 (FR) 0957329

(51) Int. Cl. F21V 29/00; F21V 7/00

(52) U.S. Cl. 362/235

(57) ABSTRACT

A lighting device includes light-emitting diodes as illuminating light sources and arranged on a support, and a receptacle housing the support of the diodes and closed by a glass substrate facing the diodes. The receptacle and the fastener to fasten the support to the receptacle, are made of a thermally conductive material. Furthermore, a scattering device to scatter light is arranged at least in zones located facing the diodes, and a reflector of light is arranged in the receptacle. The lighting device is thus thin, highly effective, and causes very little dazzle.

The invention relates to the lighting field, in particular to lighting using light-emitting diodes as light sources.

Light-emitting diodes (LEDs), which were originally used as status or indicator lights in electrical and electronic appliances have, for a few years now, been used to light signaling devices such as the signaling lights of automotive vehicles (turn signal lights, marker lights) or portable lamps or path lighting.

Recently LEDs have been developed with a view to replacing incandescent halogen bulbs.

The advantage of LEDs is their long lifetime, meaning that assemblies employing them work for longer and require less maintenance.

The aim of the invention is to provide a novel LED-based lighting device or luminaire that provides sufficient luminous efficiency without dazzling.

According to the invention, the lighting device or luminaire comprises a receptacle, light-emitting diodes as illuminating light sources, a support, which is placed in the receptacle and on which the diodes are arranged, and a glass substrate forming the cover of the luminaire, the diodes emitting light in the direction of the substrate. The luminaire is such that:
the support of the diodes is fastened to the bottom of the receptacle, the bottom of the receptacle being made of a thermally conductive metallic material and said support incorporating and/or being associated with means for dissipating heat, which means are connected to the bottom of the receptacle;
the glass substrate comprises means for scattering light, called scattering means, which means are arranged facing the diodes; and
a reflector is placed inside the receptacle so as to reflect light rays in the direction of the substrate.

The thermally conductive material of the bottom of the receptacle and the means for dissipating heat incorporated into and/or associated with the support and connected to the bottom of the receptacle form heat removal means for removing the heat generated by the diodes in operation.

Thus, the removal of the heat stops the efficiency of the diodes from decreasing and therefore guarantees that the luminous efficiency required for a luminaire is provided. The luminous efficiency is also optimized by the presence of a reflector. Furthermore, the luminaire causes very little dazzle because of the scattering means.

Furthermore, multiple advantages result from making the cover of the lighting device out of glass:
since glass has a good heat resistance, the glass substrate makes it possible to produce a thin system because it can be located near the LEDs despite the fact that they are hot spots;
this also makes it possible to use high-power (above 100 mW) LEDs, which are therefore hotter light sources, the luminous efficiency being higher (about 100 lm/W instead of 40 lm/W);
glass is smooth and mechanically strong, meaning that it is easy to clean and does not scratch, which is particularly advantageous in luminaires installed in places where a high standard of hygiene is required; and
glass meets the requirements of fire safety standards.

According to one embodiment, the support of the diodes consists of a sheet having a general area lying substantially parallel to the entire area of the bottom of the receptacle, and the reflector consists of a reflective coating added to the side of said sheet facing the substrate.

According to another embodiment, the support of the diodes consists of separate strips that are distributed over the bottom of the receptacle, and the reflector is formed by the bottom of the receptacle, the bottom of the receptacle consisting of a reflective material, and/or by a reflective coating added to the bottom of the receptacle and/or by a reflective coating added to the side of the strips facing the substrate. The reflective coating added is for example a lacquer or paint.

According to one feature, the diodes may be encapsulated or be bare chips. Moreover, it is not necessary to use lenses.

According to another feature, the means for dissipating heat incorporated into and/or associated with the support of the diodes consist of the metallic material forming the support, or of metallic areas incorporated into the support, and optionally of means for fastening the support to the bottom of the receptacle, the fastening means being thermally conductive and made of an electrically insulating material such as, thermally conductive adhesive or adhesive tape.

The scattering means facing the diodes are placed in small focal zones, i.e. zones that correspond to the focal points, in line with the diodes, and in immediate proximity to said focal points.

These zones for scattering light facing the diodes thus lie in a plane parallel to the long dimensions of the substrate. Each zone has a geometry corresponding at least to, even including, the projection onto the substrate of the light beam emitted by each of the diodes.

Each zone corresponds, for example, to an area at least bounded by a circle.

In particular, each diode facing the scattering means emits a conical light beam, the angle of the beam in the median and longitudinal planes of this cone being about 100° to 140°, and the distance from the end of the diodes to the glass substrate being about 1 to 20 mm, preferably about 10 mm.

The scattering means allow the light transmission of the substrate to be reduced. Fewer light rays are transmitted in line with the diodes, thus effectively reducing the dazzle of an individual observing the device. However, the light transmission remains high through the remaining area of the substrate, which area is free from scattering means, so as to ensure suitable illumination.

As a variant, scattering means may be associated with the entire area of the glass substrate. However, the scattering means arranged facing the diodes will have a lower light transmission than those arranged on the rest of the area of the glass.

In particular, the bare glass substrate (the substrate without scattering means) has a light transmission of at least 85% whereas, when it is associated with the scattering means arranged facing the diodes, it has a light transmission below 85%, preferably of between 40 and 85%. When other scattering means are placed in the zones separating those comprising the scattering means facing the diodes, the glass substrate associated with these other scattering means have a light transmission higher than the light transmission of the scattering means facing the diodes, and preferably of at least between 70 and 90%.

Consequently, the light transmission of the glass substrate facing the diodes is again below that of the rest of the substrate. The light emitted by this device is advantageously uniform and causes very little dazzle.

The substrate may comprise, outside the zones comprising the scattering means, a silver film covering its internal side facing the receptacle, so as to form a lighting mirror.

It may be envisioned to place scratch-resistant functional coatings on the external side facing the external environment, or optical-effect elements, such as printed elements, on the glass substrate, without hindering the operation of the luminaire.

According to another feature, the scattering means are arranged in the thickness of the glass and/or on the side of the substrate inside the device, facing the diodes. The scattering means are thus protected and the external side of the device in contact with the external environment is smooth and easy to clean.

The scattering means associated with the substrate are obtained by sandblasting the glass substrate, or by etching the glass substrate with acid, or by etching the glass substrate with some other means, preferably with a laser, or by screen printing an enamel or a scattering layer onto the glass substrate, or else they are formed by laminating a scattering plastic to the glass substrate.

The acid etching, sandblasting, etching with other means (advantageously with a laser) or screen printing will possibly be preferred because they allow the size and location of the treated zones to be easily controlled and reproduced industrially.

The substrate is mechanically fastened to the support by screwing, clipping, or adhesive bonding, preferably hermetically, or else by encapsulation.

The lighting device of the invention is used as a functional luminaire and in any setting, such as homes, industrial premises or transportation means such as trains, boats, airplanes.

Since it is flat and thin (small thickness of about 10 to 30 mm) because of its constituent elements, and because it has a glass cover that is easy to clean, the preferably hermetically sealed lighting device of the invention is particularly suited to the market for lighting of “hygienic” premises (cleanrooms, hospitals, kitchens, etc.) requiring a high IP65 protection rating.

The present invention is now described using nonlimiting examples that merely illustrate the scope of the invention and the appended drawings, in which:

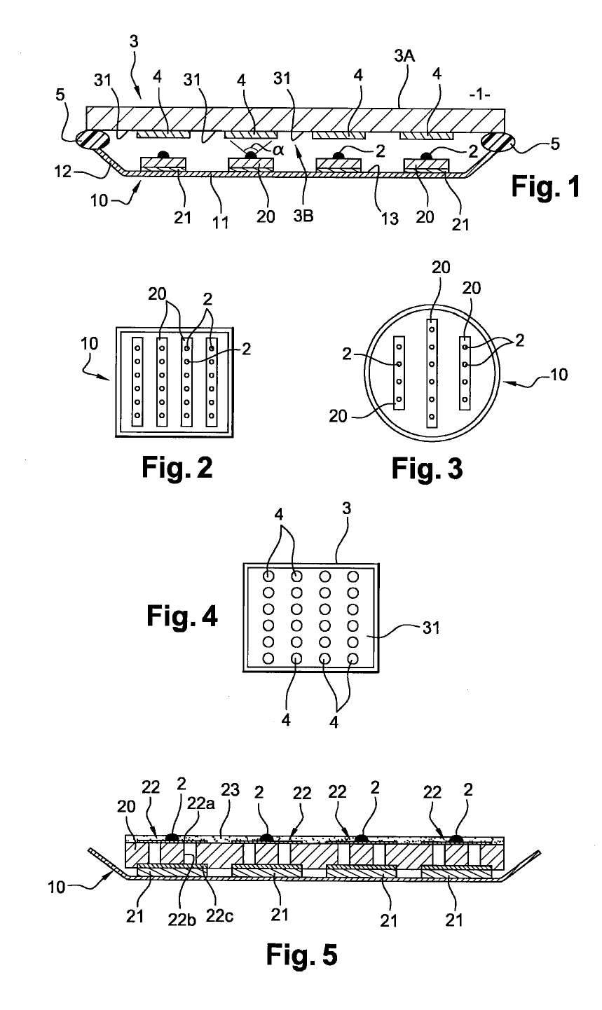

FIG. 1 shows a schematic cross-sectional view of the device of the invention;

FIG. 2 is a top view of FIG. 1 with its glass cover substrate removed;

FIG. 3 is a top view of the device of the invention, with its glass cover substrate removed, in another geometric shape;

FIG. 4 is a top view of the substrate of the device in FIG. 1;

FIG. 5 is a partial view of the luminaire of the invention with a variant LED support;

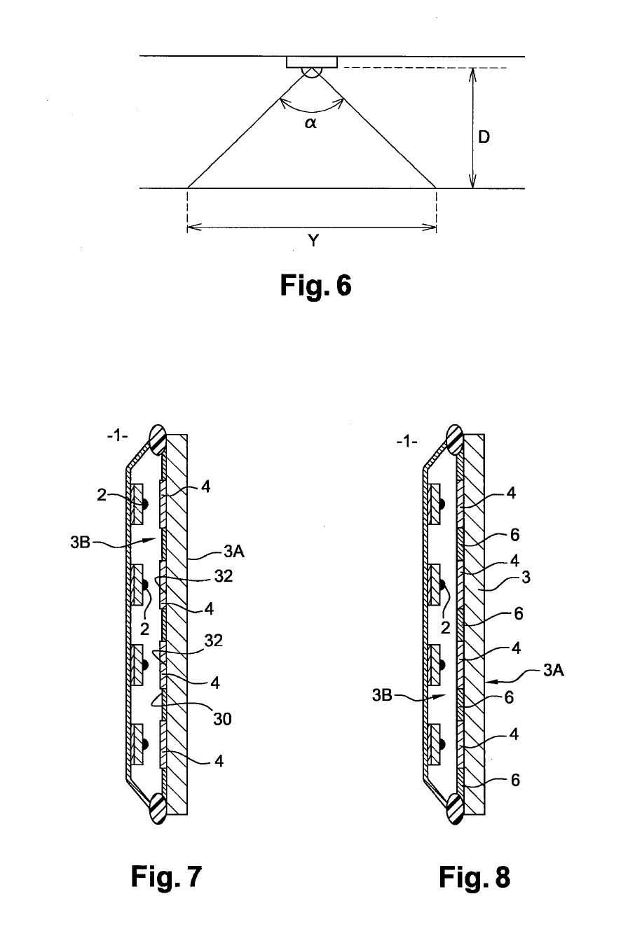

FIG. 6 is a schematic view of the light from an LED;

FIGS. 7 and 8 illustrate two cross-sectional views of two embodiments of the luminaire.

FIG. 1 illustrates a schematic view of the lighting device or luminaire 1 of the invention comprising a receptacle 10 forming the back of the luminaire, light-emitting diodes (LEDs) 2 forming the light sources and arranged in the receptacle 10, a glass substrate 3 forming the cover of the luminaire, and localized scattering means 4.

The receptacle 10 comprises a bottom 11 and inclined sidewalls 12 and is open opposite its bottom. The receptacle houses the LEDs 2 and its opening is closed by the glass substrate 3.

The glass substrate 3 is fastened to the walls 12 of the receptacle by fastening means 5, such as screws, clips, an adhesive, or an encapsulation, etc.

The receptacle 10 and glass substrate 3 when joined provide a flat structure of small bulk the overall thickness of which corresponds to the thickness of the receptacle, the height of the diode housing and the thickness of the glass substrate. The luminaire designed in this way has a small thickness of about 10 to 30 mm.

The size (length and width) of the luminaire is suited to the application made thereof, and the number of diodes then depends on this size.

The front of the luminaire may be various shapes such as a rectangle, square (FIG. 2), or circle (FIG. 3) or any other geometric shape suited to the desired design.

The receptacle 10 of the luminaire consists, according to the invention, at least for its bottom, of a thermally conductive material, such as a metal such as aluminum, copper or stainless steel.

LEDs 2 are arranged on its internal side 13, facing the substrate 3. The conductive material of the receptacle dissipates heat, thus removing the heat generated by the LEDs toward the exterior, thereby guaranteeing a high LED efficiency and increasing the lifetime of the LEDs.

The LEDs 2 are placed on a support 20 consisting, in a first embodiment illustrated in FIG. 1, of a plurality of strips, or, in a second embodiment illustrated in FIG. 5, of a sheet of printed circuit board that occupies a larger area substantially corresponding to the area of the luminaire.

The support, whether in the form of a sheet or strips, is a printed circuit board PCB. It is made of plastic or metal. Most often, the strips are made of metal whereas the sheet is made of plastic.

The advantage of the plurality of strips relative to a single sheet of PCB is that the manufacturing cost is reduced by optimizing the area used for arranging the diodes, allowing the distribution of diodes over the area of the luminaire to be flexible and thus suited to its design, and in the end allowing the maintenance cost of the luminaire to be reduced, since only the defective strip needs to be replaced.

The support 20 is fixed to the internal side 13 of the receptacle by fastening means 21 that depend on the type of support 20 used.

With regard to FIG. 1, the support consists of metal strips. The diodes are soldered to tracks that are electrically isolated from the metal of the strips. Since the metal of the strips conducts heat, the strips are pressed directly against the metal receptacle so as to dissipate heat, the fastening being achieved by clips or screws or by thermally conductive fastening means 21 such as shown in FIG. 1. The thermally conductive fastening material is for example a thermally conductive adhesive or double-sided adhesive tape, this material also being an electrical insulator.

When the support 20 is a plastic sheet (FIG. 5), the diodes are soldered to thermal pads 22 added to the two opposed sides of the sheet (referenced 22a and 22c) and through its thickness (referenced 22b). The sheet 20 is fastened by a thermally conductive fastening material 21 associated with the heat pads 22c. The thermally conductive fastening material 21 is for example a thermally conductive adhesive or double-sided adhesive tape, this material also being an electrical insulator.

The adhesive tape has the advantage of having a calibrated thickness, allowing the support of the LEDs to be perfectly planar and ensuring that the diodes are all equidistant from the substrate. In addition, the adhesive tape may be fixed beforehand to the support.

According to the invention, each diode emits a conical light beam, the angle α (FIG. 1 and FIG. 6 in greater detail) of the beam in the median and longitudinal planes of the cone being about 100° to 140°, and the distance D from the end of the diode to the glass substrate 3 being about 1 to 20 mm, preferably about 10 mm. The light spot projected onto the substrate is bounded by a circle of diameter Y equal to 2Dtan(α/2).

The luminaire advantageously comprises a reflector, i.e. an area that reflects light rays, in order for light rays that are emitted by the diodes and not directly transmitted through the substrate but trapped in the receptacle to be reflected toward the substrate so as to escape toward the exterior, thus increasing the total luminous efficiency of the luminaire.

The reflector differs depending on the embodiment of the support 20 of the LEDs.

In the strip embodiment, this reflector corresponds to the internal side 13 of the receptacle, which side has its surface suitably treated and/or an appropriate coating, such as a lacquer or paint, added.

For the sheet embodiment, which sheet lies parallel to the entire internal side 13 of the receptacle, the reflector consists of a reflective area covering the entire side 23 of the sheet facing the substrate (FIG. 5) or else smaller reflective areas arranged on the side 23 of the sheet and surrounding the LEDs and consisting for example of the thermal pads 22a (FIG. 5) or of an appropriate added coating, such as a lacquer or paint.

To ensure dazzle-free lighting, the luminaire comprises scattering means 4. These scattering means associated with the substrate 3 are appropriately distributed depending on the light produced by the LEDs. In particular, they have a geometry that corresponds to the projected area of the light beam emitted by each LED onto the substrate, the area being circular for example, as illustrated in FIG. 4.

The glass substrate 3 has a high light transmission of at least 85%. It may, by way of example, especially depending on the appearance or optical effect desired, and/or the setting of the luminaire, be:
glass of a standard composition, such as Planilux® glass from Saint-Gobain Glass, having a slight green color;
Colorless (neutrally colored) extra-clear glass such as Diamant® glass from Saint-Gobain Glass;

glass printed with pyramids, such as Albarino® glass from Saint-Gobain Glass, pyramid-shaped reliefs being produced in the external side 3A of the substrate facing the external environment of the luminaire;
tempered glass, which is stronger; and
laminated glass.

According to one embodiment, the glass substrate may form a lighting mirror as illustrated in FIG. 7. The glass substrate 3 is a transparent glass sheet one side of which, the internal side 3B facing the interior of the luminaire, is provided with a reflective coating 30, such as a silver-based film, outside of certain zones 32 so as to ensure light transmission. The scattering means 4 are placed in these zones 32, facing the diodes. Preferably, for this application, the scattering means are obtained by sandblasting the reflective film, so as to simplify manufacture.

According to the invention, the glass substrate 3 comprises scattering means 4 that modify the light transmission of the substrate so that the light transmission of the substrate lies between 40 and 85%.

The scattering means 4 are located and arranged at least facing the LEDs. The means are then placed in small, typically circular, focal zones facing the diodes.

The scattering means prevent the light rays emitted by the LEDs from being too intense when transmitted, substantially reducing the dazzle of an individual looking toward the luminaire.

The light rays that were not transmitted via the substrate are reflected by the scattering means toward the interior of the device. The reflector (internal side 13 of the receptacle and/or surface coating on the sheet supporting the LEDs) advantageously reflects said light rays toward the substrate, the escaping light rays thus being scattered and mainly escaping via the zones of the substrate 31 free from scattering means.

The lighting thus has a particularly high luminous efficiency of at least 40 lm/W (lumens/watt), while being uniform and causing very little dazzle. The efficiency is usually measured, with the aid of a goniometer, at room temperature.

By way of example, a device according to the invention that is 600 mm long and 600 mm wide and that comprises fifty LEDs each achieving an efficiency of 70 lm/W after their temperature has stabilized, provides a total efficiency for the luminaire of 54 lm/W. The optical efficiency of the luminaire (ratio of the total efficiency to the efficiency of a diode) is, in this example, 77%, i.e. above 70%. Furthermore, the luminaire may be made still more efficient by using LEDs with a luminous efficiency above 70 lm/W.

The scattering means 4 are arranged in the thickness of the glass and/or on the internal side 3B of the substrate facing the support. The scattering means are obtained by sandblasting, or acid etching, such as carried out on Satinovo® glass from Saint-Gobain Glass, or by laser etching, or else by screen printing an enamel or a scattering layer, such as carried out on Smoothlite® glass from Saint-Gobain Glass. Screen printing has the advantage of allowing any type of design to be obtained with well defined edges.

In another variant, a scattering plastic is used to form the scattering means, when the substrate is made of laminated glass.

The scattering means 4 are, as described above, advantageously distributed in locations facing the diodes, it being essential for the light transmission obtained in these locations to be lower than for the rest of the substrate. However, in an embodiment such as illustrated in FIG. 8, other scattering means 6 could be placed in the zones separating said scattering means 4, these other means being produced by similar methods (etching, sandblasting, acid etching, etc.). Nevertheless, these other scattering means 6 must have a higher light transmission than said scattering means 4.

Thus, the luminaire of the invention provides, by combining LEDs and the glass substrate equipped with scattering means facing the LEDs, efficient lighting that is uniform and causes very little dazzle, the scattering means ensuring the light transmission is distributed and locally modulated over the area of the glass.

Moreover, the reflector arranged appropriately in the receptacle allows light to be reflected toward the substrate, maximizing the efficiency of the illumination output by the luminaire.

Furthermore, the thermal conductivity of the receptacle, of the support of the LEDs and of the means for fastening the support to the receptacle, ensures that the heat generated by the LEDs is dissipated and does not reduce the efficiency of the luminaire.

Finally, using LEDs as light sources provides a extremely thin luminaire.

1. A lighting device comprising a receptacle, light-emitting diodes as illuminating light sources, a support, which is placed in the receptacle and on which the diodes are arranged, and a glass substrate forming the cover of the device, the diodes configured to emit light in the direction of the substrate, wherein:
the support of the diodes is fastened to the bottom of the receptacle, the bottom of the receptacle being made of a thermally conductive metallic material and said support incorporating and/or being associated with a heat dissipating device configured to dissipate heat, which heat dissipating device is connected to the bottom of the receptacle;
the glass substrate comprises a scattering device configured to scatter light, which scattering device is arranged facing the diodes; and
a reflector is placed inside the receptacle so as to reflect light rays in the direction of the substrate.

2. The lighting device as claimed in claim 1, wherein the support of the diodes consists of a sheet having a general area lying substantially parallel to the entire area of the bottom of the receptacle, and the reflector consists of a reflective coating added to the side of said sheet facing the substrate.

3. The lighting device as claimed in claim 1, wherein the support of the diodes consists of separate strips that are distributed over the bottom of the receptacle, and the reflector is formed by the bottom of the receptacle, the bottom of the receptacle consisting of a reflective material, and/or by a reflective coating added to the bottom of the receptacle and/or by a reflective coating added to the side of the strips facing the substrate.

4. The lighting device as claimed in claim 1, wherein the heat dissipating device incorporated into and/or associated with the support of the diodes consists of the metallic material forming the support, or of metallic areas incorporated into the support, and optionally of a fastener configured to fasten the support to the bottom of the receptacle, the fastener being thermally conductive and made of an electrically insulating material.

5. The lighting device as claimed in claim 1, wherein the scattering device is arranged in zones each of which has a geometry corresponding at least to the projection onto the substrate of the light beam emitted by each of the diodes.

6. The lighting device as claimed in claim 5, wherein each zone corresponds to an area at least bounded by a circle, the light beam of each diode forming a light cone, the angle of the beam in the median and longitudinal planes of the cone being about 100° to 140°.

7. The lighting device as claimed in claim 1, wherein the bare glass substrate has a light transmission of at least 85% whereas, when the bare glass substrate is associated with the scattering device, the bare glass substrate has a light transmission below 85%.

8. The lighting device as claimed in claim 1, comprising another scattering device placed in the zones separating those comprising the scattering device facing the diodes, the glass substrate associated with the other scattering device having a light transmission higher than the light transmission of the scattering device facing the diodes.

9. The lighting device as claimed in claim 1, wherein the substrate comprises, outside the zones comprising the scattering device, a reflective film, covering an internal side thereof facing the receptacle, so as to form a lighting mirror.

10. The lighting device as claimed in claim 1, wherein the scattering device is arranged in the thickness of the glass and/or on the internal side of the substrate facing the diodes.

11. The lighting device as claimed in claim 1, wherein the substrate is mechanically fastened to the receptacle by screwing, clipping, or adhesive bonding, or else by encapsulation.

12. The lighting device as claimed in claim 1, wherein the lighting device has a substantially flat and thin shape of small thickness, between about 10 and 30 mm.

13. The lighting device as claimed in claim 4, wherein the fastener is made of a thermally conductive adhesive or adhesive tape.

14. The lighting device as claimed in claim 7, wherein, when the bare glass substrate is associated with the scattering device, the bare glass substrate has a light transmission between 40 and 85%.

15. The lighting device as claimed in claim 8, wherein the glass substrate associated with the other scattering device have a light transmission higher than the light transmission of the scattering device facing the diodes of at least between 70 and 90%.

16. The lighting device as claimed in claim 11, wherein the substrate is hermetically fastened to the receptacle.
